(19) United States
(12) Patent Application Publication
(10) Pub. No.: US 2025/0370793 A1
(43) Pub. Date: Dec. 4, 2025

(54) POLICY-BASED EXECUTION OF COMMANDS IN A DISTRIBUTED COMPUTING ENVIRONMENT

(71) Applicant: Salesforce, Inc., San Francisco, CA (US)

(72) Inventors: Vipin Balachandran, San Francisco, CA (US); Ashish Mahajan, San Francisco, CA (US)

(21) Appl. No.: 18/676,204

(22) Filed: May 28, 2024

(51) Int. Cl. G06F 9/48

(52) U.S. Cl. CPC G06F 9/4881

(57) ABSTRACT

A policy-based approach to execution of commands in a distributed environment involves applying policies to determine permissions for executing commands. In some implementations, a user inputs a command at a web portal, causing a request to be sent to a computer system. The web portal also sends an indication of one or more machine components of a remote system to which the command is to be applied. After identifying a policy associated with the user, the computer system evaluates a rule in the policy to determine whether the user is permitted to execute the command with respect to the one or more machine components. The computer system routes the command to the remote system for execution based on determining that the rule is satisfied. This enables the command to be executed without providing the user with direct or unrestricted access to the remote system.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates generally to managing access to a remote system, more particularly, to controlling the ability of users to execute commands on the remote system using policies that govern access.

### BACKGROUND

In a distributed computing environment, users sometimes want to run commands remotely. For instance, a software developer may wish to execute a command for obtaining information about the current state of a remote computer. This can occur in the context of debugging remotely deployed software, but other situations exist where a user command is to be executed remotely.

### BRIEF DESCRIPTION OF THE DRAWINGS

The included drawings are for illustrative purposes and serve only to provide examples of possible structures and process operations for the disclosed techniques. These drawings in no way limit any changes in form and detail that may be made to implementations by one skilled in the art without departing from the spirit and scope of the disclosure.

FIG. 1 is a diagram of an example computing environment incorporating one or more implementations.

FIG. 2 shows an example of a web portal for receiving commands, according to some implementations.

FIG. 3 shows an example of a mapping between roles and policies, according to some implementations.

FIG. 4 is a high-level conceptual illustration of a policy, according to some implementations.

FIG. 5 shows an example of a web portal for providing input regarding a command from another user, according to some implementations.

FIG. 6 shows an example of an activity log, according to some implementations.

FIG. 7 is a flow diagram of a process for determining whether to allow a command to be executed on a remote system, according to some implementations.

FIG. 8 is a flow diagram of a process for responding to a command request initiated through a web portal, according to some implementations.

FIG. 9A shows a system diagram illustrating architectural components of an applicable environment, in accordance with some implementations.

FIG. 9B shows a system diagram further illustrating architectural components of an applicable environment, in accordance with some implementations.

FIG. 10 shows a system diagram illustrating the architecture of a multi-tenant database environment, in accordance with some implementations.

FIG. 11 shows a system diagram further illustrating the architecture of a multi-tenant database environment, in accordance with some implementations.

### DETAILED DESCRIPTION

Examples of techniques for managing access to a remote system are described herein with reference to certain implementations. In particular, aspects of the present disclosure are directed to a policy-based approach to determining whether a user is permitted to execute a command on a remote system. In some implementations, the remote system is a software production system used to deploy software applications, and the policies are maintained on a computer system acting as an intermediary between a user's computing device and the production system. However, the techniques described herein can be applied to other computing environments. Thus, the described examples are being provided solely to add context and aid in the understanding of the present disclosure. It will be apparent to one skilled in the art that the techniques described herein may be practiced without some or all of these specific details. In other instances, well known process operations have not been described in detail in order to avoid unnecessarily obscuring the present disclosure. Other applications are possible, such that the following examples should not be taken as definitive or limiting either in scope or setting.

The described subject matter may be implemented in the context of a computer-implemented system, such as a software-based system, a database system, a multi-tenant environment, or the like. Moreover, the described subject matter may be implemented in connection with two or more separate and distinct computer-implemented systems that cooperate and communicate with one another. One or more examples may be implemented in numerous ways, including as a process, an apparatus, a system, a device, a method, a computer-readable medium such as a non-transitory computer-readable storage medium containing computer-readable instructions or computer program code, or as a computer program product comprising a computer usable medium having a computer-readable program code embodied therein.

In a distributed computing environment, situations may arise where a user wants to run a command remotely. For example, a software developer may become aware of a technical problem relating to a software application that the developer contributed to. The software application may be stored or running on a software production system, e.g., deployed on one or more pods in a Kubernetes environment. To investigate the problem and begin debugging, the developer may be interested in obtaining information about the current state of the pod(s) that the software application is running on. One way to obtain such information is by executing a diagnostic command after logging into the production system. However, access to production systems is typically highly restricted, with only a few trusted users (e.g., a group of administrative developers) being assigned the necessary privileges to log in.

The developer can seek permission to log into the production system by going through steps such as asking an administrator to associate the developer with a user account having the necessary privileges, which can take a long time. More importantly, direct access to a production system is generally discouraged. When a user logs into a production system, this is sometimes referred to as a “break glass” scenario because such access is typically reserved for emergency situations. At this point, the user is no longer a passive observer. Once logged in, there are usually no mechanisms in place to prevent the user from executing potentially destructive commands (e.g., changing a machine configuration or deleting stored content). The user may not necessarily intend to execute a destructive command. However, even a minor error such as misspelling a command could affect the production system in unexpected ways, with one or more components (e.g., a single pod or an entire cluster of pods) being adversely impacted.

Continuing with the example above, an alternative method of enabling the developer to do debugging is to give the developer access to data metrics or activity logs. These metrics or logs may be generated by a third-party analytics platform such as Splunk (available from Splunk Inc. of San Francisco, CA) or a monitoring program such as Argus, which is an open-source systems and network monitoring application. However, it may be difficult to debug in real time since the metrics or logs are usually collected over a certain period. The latency with which the data arrives (e.g., several minutes from the time the developer requests an activity log) may result in the data become too stale to be of use. By contrast, there is little or no latency when executing commands remotely because the remote system is directly responsible for execution. Accordingly, it would be advantageous to provide a way for users to remotely execute commands (e.g., for debugging or other purposes) while maintaining trust between the user and the remote system where the commands are executed. These and other challenges are addressed in various examples described below and illustrated throughout the drawings.

In the example implementations described below, information processed by a computer system to provide the functionality disclosed herein can be organized as data structures that are stored, for example, in memory or in one or more databases. Examples of such data structures, which can be arranged as database records or data objects, are provided for illustration purposes only. One skilled in the art will understand that the information in the data structures can be organized in different ways, including combining or splitting of data structures so that the information is stored in a more collected or distributed fashion.

The disclosed implementations may include a computer-implemented method including receiving, by a computer system through a web portal, a request to execute a command on a remote system, where the request is generated in response to a user inputting the command at the web portal. The method further includes receiving, by the computer system through the web portal, an indication of one or more machine components of the remote system to which the command is to be applied; and identifying, by the computer system, a policy associated with the user. The policy includes a rule governing usage of the command. The method further includes evaluating, by the computer system, the rule to determine whether the user is permitted to execute the command with respect to the one or more machine components. Additionally, the method includes routing, by the computer system, the command to the remote system for execution based on determining that the rule is satisfied.

The disclosed implementations may include a computer system with one or more processors and memory storing instructions that, when executed by the one or more processors, cause the computer system to receive, through a web portal, a request to execute a command on a remote system, where the request is generated in response to a user inputting the command at the web portal. The instructions further cause the computer system to receive, through the web portal, an indication of one or more machine components of the remote system to which the command is to be applied; and to identify a policy associated with the user. The policy includes a rule governing usage of the command. The instructions further cause the computer system to evaluate the rule to determine whether the user is permitted to execute the command with respect to the one or more machine components. Additionally, the instructions cause the computer system to route the command to the remote system for execution based on determining that the rule is satisfied.

The disclosed implementations may include a non-transitory computer-readable medium storing program code, the program code including instructions that are executable by one or more processors of a computer system to configure the computer system to perform any of the methods disclosed herein.

Any of the disclosed implementations may be used alone or together with one another in any combination. The one or more implementations encompassed within this specification may also include examples that are only partially mentioned or alluded to or are not mentioned or alluded to at all in this brief summary or in the abstract. Although various implementations may have been motivated by various deficiencies with the prior art, which may be discussed or alluded to in one or more places in the specification, the implementations do not necessarily address any of these deficiencies. In other words, different implementations may address different deficiencies that may be discussed in the specification. Some implementations may only partially address some deficiencies or just one deficiency that may be discussed in the specification, and some implementations may not address any of these deficiencies.

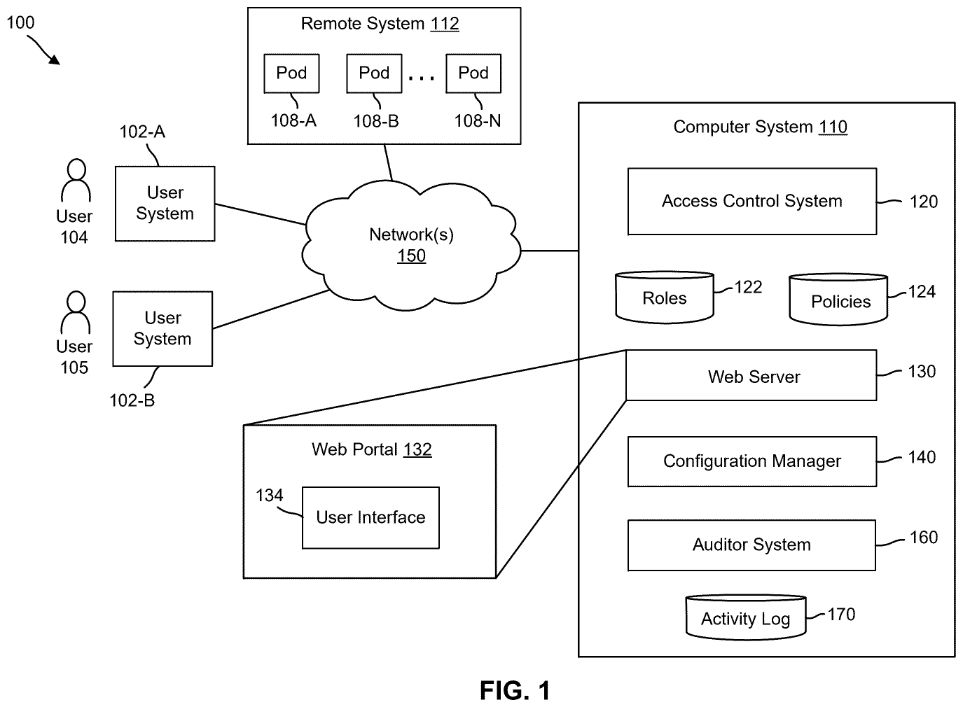

FIG. 1 is a diagram of an example computing environment 100 incorporating one or more implementations. The environment 100 includes a computer system 110 and user systems 102 operated by various users. For simplicity, FIG. 1 shows only two users, a first user 104 operating a user system 102-A and a second user 105 operating a user system 102-B. A user system 102 may be any machine or system that is used to communicate with a remote system such as the computer system 110. For example, a user system 102 can be embodied as a standalone computing device (e.g., a mobile phone or laptop computer) or a combination of devices configured to provide computing functionality, e.g., a desktop computer or workstation in combination with peripheral devices, or a network of computing systems. The users of the user systems 102 may belong to the same organization. For example, the users 104 and 105 may be software developers working for the same company, with user 105 being responsible for supervising the work of user 104. In some instances, users may be unrelated to each other. Users may be assigned different roles 122 which determine the level of access a user has to a remote system. In some instances, access by a user involves executing a command on the remote system. Aspects of the present disclosure are directed to techniques for enabling users to execute certain commands while maintaining the security of the remote system.

In the example of FIG. 1, the remote system on which commands are executed is a remote system 112 having one or machine components. These machine components may include computing resources used to provide computing, storage, and/or other services. By way of example, the remote system 112 may include one or more machine components that form a production system for deployment of software. The production system may be configured to execute software programs or otherwise make software available (e.g., through download and installation on a local computer). In some instances, the software maintained on the production system may be authored by one or more users (e.g., the user 104 and/or the user 105).

A machine component may include a physical machine with one or more hardware processors, e.g., a central processing unit (CPU) with one or more processor cores. Alternatively or additionally, a machine component may include a virtual machine that emulates the behavior of a physical machine. In various implementations, the machine components of the remote system 112 may correspond to pods 108 (e.g., a first pod 108A, a second pod 108B, etc.). Each pod 108 may represent a collection of computing resources, e.g., a Kubernetes pod containing resources associated with a software production system. The pods 108 may be organized into clusters, which may or may not have overlapping functionality. For example, a first cluster may act as a provider of a service not provided by a second cluster, but both clusters may provide a second service.

Communications within the computing environment 100 may occur over one or more networks 150 that communicatively couple the user systems 102, the computer system 110, and the remote system 112. The network(s) 150 can include wired and/or wireless networks and may be implemented as a private network (e.g., a local area network or private area network), a public network (e.g., the Internet), or a combination of private and public networks. Some users may be able to access the remote system 112 directly, for example, by logging in to establish a terminal session that enables the user to access a pod 108. Access to the remote system 112 may be restricted to a subset of users. For example, the user 105 may be assigned a username, a password, and/or other credentials that enable the user 105 to log into the remote system 112, while the user 104 may have no such credentials. However, there may be times when the user 104 wants to access the remote system 112, e.g., to investigate and troubleshoot/debug a problem associated with a particular pod or cluster. In order to begin debugging, the user 104 may request permission to log into the remote system 112. However, as discussed earlier, this can take a long time and leads to a break glass scenario in which the remote system may become compromised (e.g., as a result of the user 104 inputting a wrong command).

To allow users to execute commands without logging into the remote system 112 while also limiting the use of destructive commands, the computer system 110 can be configured to operate as an intermediary between a user system (e.g., the user system 102-A) and the remote system 112. The computer system 110 is described in further detail below and includes a portal 132 through which the computer system 110 can receive commands from user systems 102. The computer system 110 may apply role-based access control (RBAC) to determine whether to route a command to the remote system 112 for execution. In this way, a user interacting with the portal 132 may be restricted to executing only commands which are permitted for the role(s) assigned to the user.

Computer system 110 can be configured as a collection of subsystems which cooperate with each other to provide the functionality associated with the computer system 110. For instance, the computer system 110 may include an access control system 120, a server 130, a configuration manager 140, and an auditor system 160. Each of these subsystems can be implemented using one or more processors and memory storing instructions that are executed by the processor(s) to perform the various operations described herein. In some instances, different subsystems may share hardware or computing resources. Subsystems may also be combined or arranged differently than as shown in FIG. 1.

Computer system 110 can include a memory system (not shown) formed of one or more memory devices. The memory system may be configured to provide persistent storage for data operated on by the subsystems. The data can be organized into various data structures and, in some instances, may be stored in a database. Examples of such data include roles 122, policies 124, and an activity log 170. In addition, the memory subsystem may be configured to provide for temporary storage of data. For example, the memory subsystem may include buffer memory, cache memory, and/or other types of working memory that store data for quick access during operations of the subsystems. Thus, the computer system 110 may include volatile and non-volatile memory/storage devices.

Access control system 120 is configured to apply permissions-related information to determine whether to grant access to the remote system 112. In particular, the access control system 120 can apply the roles 122 and the policies 124 to determine whether to route an incoming command, received from the portal 132, to the remote system 112 for execution. Roles 122 may correspond to logical subdivisions of work functions. Thus, a role can be related to a user's job title, e.g., a role of “level 1 software developer”. However, in practice, roles tend to represent higher level abstractions of work that may be performed by a user. For example, a group of software developers working on the same project may have a set of roles assigned, where the roles represent different aspects of the project. Some members of the group may be assigned the same role, and some members may be assigned multiple roles. The roles 122 may be defined by one or more administrators of the remote system 112.

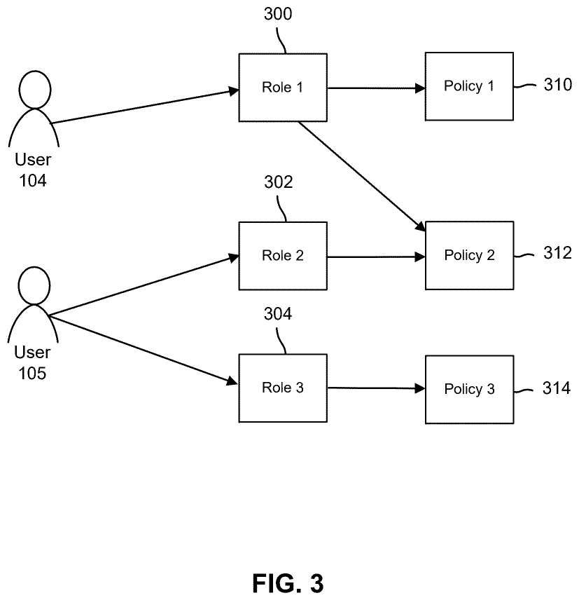

Policies 124 may correspond to data objects that specify what types of actions are permitted or unpermitted with respect to computing resources managed by the computer system 110. In particular, the policies 124 may include one or more policies governing access to the remote system 112. The policies 124 may be evaluated by the access control system 120 in connection with access requests, e.g., a request to execute a command at the remote system 112. A policy may be digitally encoded in the form of one or more rules. For example, at least some of the policies 124 may include logical expressions or conditional statements that are defined programmatically by the same administrator(s) who define the roles 122. In some implementations, a policy may be in the form of a software algorithm or program that can be executed to evaluate rules and generate a decision for the access control system 120. As discussed below in reference to FIG. 3, a policy may be associated with one or more roles. Thus, each role of the roles 122 may be mapped to one or more policies of the policies 124. In this manner, the role(s) to which a user has been assigned may determine which policy or policies the access control system 120 will evaluate when deciding whether to grant or deny the user's access requests.

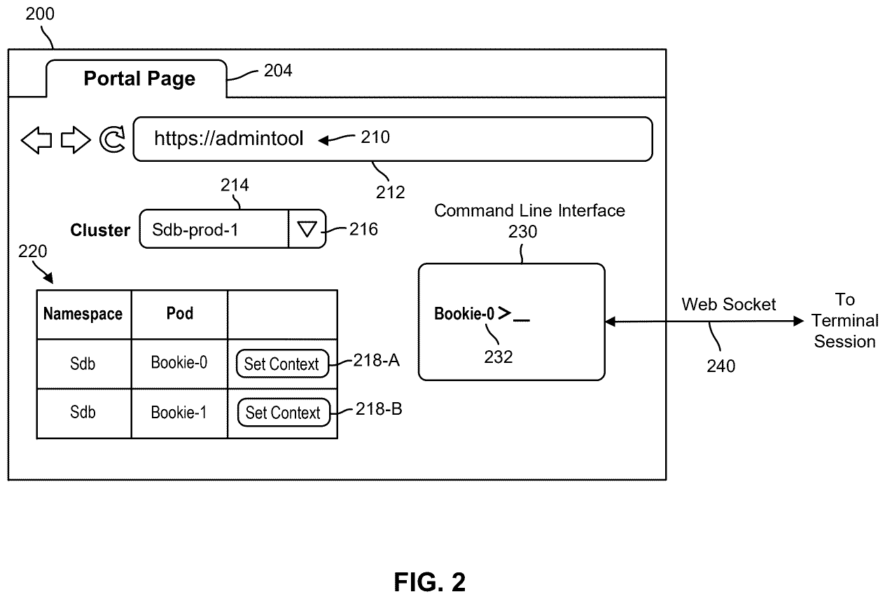

Server 130 is configured to host the portal 132, which is accessed by user systems 102. In some implementations, the portal 132 is accessed via a Uniform Resource Locator (URL). Accordingly, the portal 132 is shown as a web portal in FIG. 1, and the server 130 may be a web server. The portal 132 may include a user interface 134 configured to receive input from, and present output to, a user. For example, the user interface 134 may be a graphical user interface in the form of a web page displayed through a web browser of a user system 102. An example implementation of the user interface 134 is shown in FIG. 2, discussed below. In FIG. 2, the user interface includes a text-based command line interface (CLI) for receiving commands via text input. Commands entered into the CLI can include commands to be executed by the remote system 112. The user interface 134 may also accept other forms of input, e.g., through navigation menus, clickable links, radio buttons, checkboxes, and/or other graphical control elements. The server 130 may treat each command received through the portal 132 as a separate access request, e.g., a request to execute the command at the remote system 112. In response to an incoming command, the access control system 120 may determine which policy or policies apply to the command and decide whether the command will be allowed. If the access control system 120 returns a response indicating that the command is allowed, then the server 130 may route or forward the command to the remote system 112 for execution. Otherwise, the server 130 may ignore the command and output an error message to the user via the portal 132.

Configuration manager 140 is configured to monitor the remote system 112 for configuration changes in the remote system. For instance, the configuration manager 140 may periodically check the remote system 112 to determine what machine components are available (e.g., identifying individual pods) and how the machine components are organized (e.g., mapping cluster topology). In this manner, the configuration manager 140 may enumerate the computing resources available from the remote system 112. Additionally, the configuration manager 140 may be responsible for determining how to communicate with the remote system 112. For example, the configuration manager 140 may keep track of hardware or network addresses, port assignments, or communication channels that the computer system 110 can use for transmitting messages to, or receiving messages from, specific components of the remote system 112.

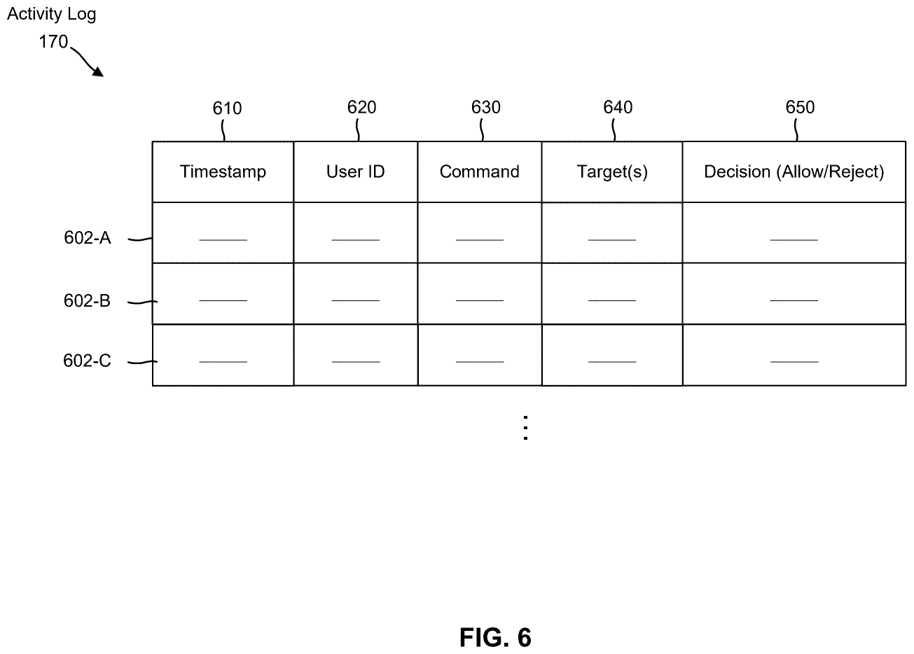

Auditor system 160 is configured to record user activity. For example, the auditor system 160 may create an entry in the activity log 170 each time a command is received from the portal 132. The activity log entries may contain information about the command, the user who supplied the command, and other information related to actions initiated by users with respect to the remote system 112. The activity log 170 may act as a trusted source of historical information usable for auditing and other purposes. For example, if unexpected behavior is detected at the remote system 112, an administrator may review the activity log 170 to determine whether the unexpected behavior is attributed to execution of a specific command and take appropriate remedial action. An example implementation of the activity log 170 is shown in FIG. 6, discussed below.

FIG. 2 shows an example of a web portal 200 for receiving commands, according to some implementations. The web portal 200 may correspond to an instance of the portal 132 in FIG. 1 and includes a web page 204 accessible through inputting a URL 210 into an address bar 212 of a web browser. The web browser may be executed on a user system 102 to present the web portal 200 on a display monitor of the user system. FIG. 2 is merely an example to illustrate portal features which are relevant to executing user commands. In other implementations, a portal may be configured differently, e.g., with a different combination and/or arrangement of user interface elements. Thus, it will be understood that the web portal 200 can be realized in other ways. Further, the manner in which the web portal 200 is accessed by a user may also depend on implementation. For instance, the web portal 200 may be accessed through a dedicated software application running on a user system 102 instead of a web browser. The web portal 200 may also be a component of a larger program or software suite having additional functionality not necessarily related to command execution. For example, in some implementations, the web portal 200 may be accessed by logging into a website using single sign-on (SSO) authentication. In addition to the web portal 200, the website may provide access to an electronic message board, a content sharing platform (e.g., a company's internal knowledge base), a customer relationship management (CRM) tool, a human resource management tool, and/or other enterprise software tools.

As shown in FIG. 2, the web portal 200 may include a user interface with graphical elements for receiving user input and/or graphical elements for presenting output to a user. For example, the web portal 200 may include a dropdown menu 214 triggered using a button 216. Activation of the button 216 expands the menu 214 to present a list of available clusters to the user. In FIG. 2, the currently selected cluster is “Sdb-prod-1” and may correspond to one of several pod clusters in a software production system.

Web portal 200 may further include a table 220 that displays a list of resources associated with the selected cluster. For example, in response to user selection of the cluster Sdb-prod-1, the table 220 may be updated to display a list of namespaces in a first column and a list of pods in a second column. Namespaces are used to isolate different groups of resources, e.g., resources within an individual cluster. Each resource in a namespace may be assigned a unique name or other identifier to distinguish from other resources in the same namespace. For instance, cluster Sdb-prod-1 may have a namespace “Sdb” representing resources used to provide a database service. In this example, the resources assigned to the namespace Sdb include a first pod named “Bookie-0” and a second pod named “Bookie-1”. Each of these two pods may be configured to run a database application programmed to respond to a set of commands. The commands recognized by the database application may be specific to the database application but can also include commands recognized by other applications running within the cluster Sdb-prod-1.

Web portal 200 may be configured to permit the user to specify one or more machine components as being the target of commands the user will input. For example, as shown in FIG. 2, the table 220 may include a third column containing options 218 for setting the current context to a particular pod. To set the context to Bookie-0, the user can select a first option 218-A. Similarly, the user can select a second option 218-B to set the context to Bookie-1. In this manner, the user may choose a machine component in which to execute commands. Context can be specified at various levels of granularity and is not necessarily limited to individual pods. For example, in some implementations, the web portal 200 may permit the user to set the context to an entire namespace, a set of namespaces, a subset of pods within a namespace, a set of clusters, etc. Thus, a user command may be executed on any number of machine components, e.g., on multiple pods concurrently.

After setting the context (e.g., by selecting one of the options 218), the user of the web portal 200 can begin inputting commands for execution. The web portal 200 may include a CLI 230 for inputting commands. Each command is entered into the CLI 230 as a text string. The CLI 230 may be initially hidden or in a default state until the user sets the context. For example, the CLI 230 may be blank when the web portal 200 is first loaded in the web browser. Upon selection of the option 218-A, the CLI 230 may be updated to display a prompt 232 indicating that the context has been set to Bookie-0. The prompt 232 may end with a blinking cursor corresponding to the space where the next command will appear as the user enters the next command by typing a sequence of characters.

When the user submits a command (e.g., by pressing the “Enter” key on a keyboard to transition the CLI 230 to a new command line), the web portal 200 may communicate the command through a web socket 240. The web socket 240 may be a connection to a terminal session established by the server 130. In some implementations, the terminal session may be configured to behave in a similar manner as a native terminal session established by a remote system. For example, the CLI 230 may be substantially similar or identical in appearance to a CLI that would be presented to a user logged directly into the remote system 112. The information displayed in the CLI 230 and the way the CLI 230 responds to user input may also be substantially similar or identical to the CLI of the remote system 112. Thus, the computer system 110 may use the CLI 230 to establish a terminal session that mimics a native terminal session. In some instances, the user may not even be aware that they are interacting with the computer system 110 rather than the remote system 112.

FIG. 3 shows an example of a mapping between roles and policies, according to some implementations. In this example, the user 104 has been assigned a first role 300, while the user 105 has been assigned a second role 302 and a third role 304. The roles 300, 302, and 304 may correspond to the roles 122 in FIG. 1. Here, the first role 300 is mapped to a first policy 310 and a second policy 312. The second role 302 is also mapped to the second policy 312. The third role 304 is mapped to a third policy 314. The policies 310, 312, and 314 may correspond to the policies 124 in FIG. 1. Accordingly, if the user 104 submits a command for execution, the computer system 110 may apply the first policy 310 and/or the second policy 312 to determine whether to route the command to the remote system 112. Similarly, if the user 105 submits a command for execution, the computer system 110 may apply the second policy 312 and/or the third policy 314 to determine whether to route the command to the remote system 112.

When a user is associated with multiple policies, as in FIG. 3, the computer system 110 may apply the policies in a certain order. Further, it is not always the case that all the policies are applied, as there may be instances where the computer system 110 reaches a decision without exhausting every policy associated with a user. For example, in the case of user 104, the computer system 110 may evaluate the rules of the first policy 310 before evaluating the rules of the second policy 312. If the computer system 110 determines that the user 104 should be permitted to execute a command based on a particular rule in the first policy 310, the computer system 110 need not evaluate any remaining rules in the first policy 310 or any of the rules in the second policy 312. Once it has been determined that the conditions for granting permission to execute a command have been satisfied, the computer system 110 can forward the command to the remote system 112 for execution.

Another reason why not all policies are applied may be that the policies cover different sets of commands, so that only some of the policies include a rule pertaining to a particular command. For example, there may be no overlap between the commands to which the first policy 310 applies and the commands to which the second policy 312 applies. Thus, the policies applied by the computer system 110 may depend on the identity of the user and/or the command for which permission is being sought.

In some implementations, the mapping between a role and a policy may be specified in a role definition file, so that each role includes a grouping of one or more policies. The role definition may be encoded in a human-readable format. An example role definition in YAML format for a role named “role1” having two policies named “policy1” and “policy2” could be as follows:
type: role
metadata:
name: role1
policies:
   policy1
   policy2

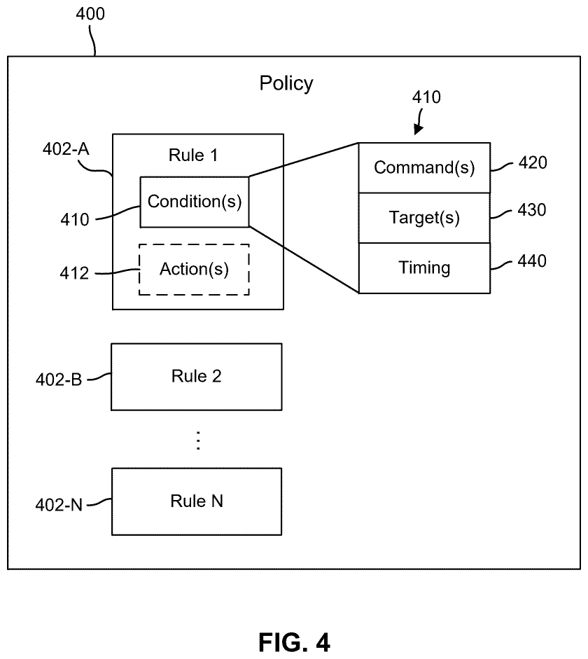

FIG. 4 is a high-level conceptual illustration of a policy 400, according to some implementations. Policies may differ with respect to their capabilities. Some policies may be less restrictive, e.g., permitting a majority of the available commands, including one or more commands that make configuration changes to a remote system. Other policies may be more restrictive, e.g., permitting only a small subset of read-only commands. In the example of FIG. 4, the policy 400 includes one or more rules 402 (e.g., a rule 402-A, a rule 402-B, and a rule 402-N). Each rule 402 may include one or more conditions 410. The condition(s) 410 may be expressed in different ways, e.g., as logical conditions that evaluate to a boolean (true/false) result. In some implementations, the condition(s) 410 may represent search terms that are matched against a command request (i.e., a request to execute a particular command). Thus, a rule 402 may include one or more match clauses that form a regular expression (RegEx) pattern. Conditions can include one or more commands 420, one or more targets 430, and/or timing conditions 440. The command(s) 420 may correspond to a subset of commands recognized within an execution environment (e.g., the remote system 112). The target(s) 430 may correspond to a subset of machine components or resources (e.g., one or more pods) within the execution environment. Timing conditions 440 may represent constraints on when a command can be executed.

If all the conditions 410 of a rule 402 are met by a command request, then the rule may be deemed satisfied, and the command may be allowed to execute (e.g., by routing the command to the remote system 112). However, in some instances, evaluation of a rule may involve triggering one or more actions 412 associated with the rule. An action 412 may include one or more steps performed by the computer system 110 and/or another computer system. For example, an action 412 may be implemented using a web hook that is called whenever there is a match to the conditions 410. The web hook may trigger functionality provided as an external service, such as an email or instant messaging service operated independently of the computer system 110. Actions 412 can operate as additional conditions. If a rule includes multiple actions 412, every action may be required to execute successfully (e.g., to completion) before a command is allowed.

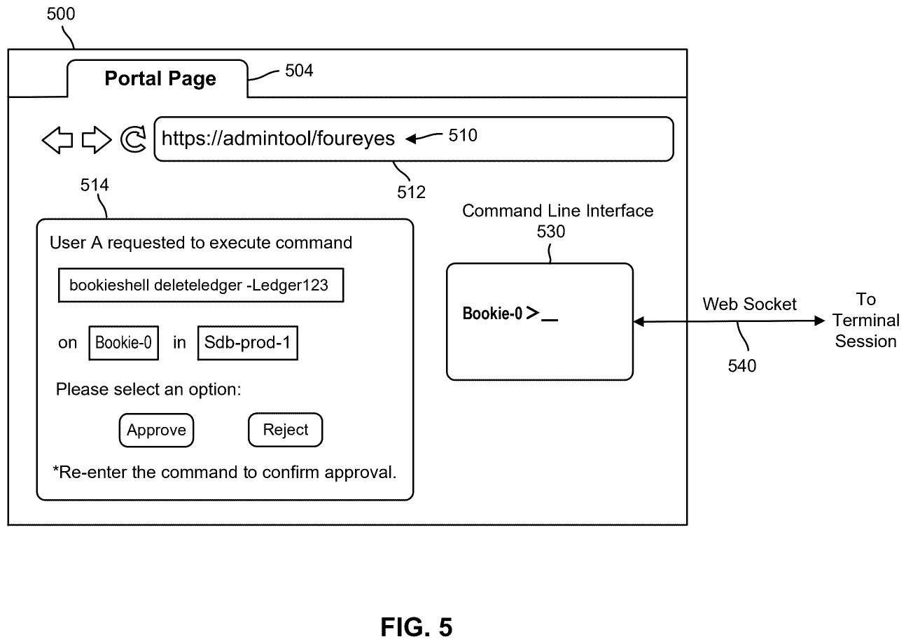

In some instances, an action 412 may result in an electronic communication being sent to the user who initiated the request or to another user. The electronic communication can be purely informational, e.g., a message confirming that the command has been approved for execution. Alternatively, the electronic communication may prompt the recipient to provide input as an additional condition for granting the request. For example, execution of certain commands may require approval from at least two users. This is sometimes referred to as the Four Eyes Principle or two-person rule. The first user may correspond to the user who initiated the request (e.g., user 104), in which case the approval of the first user is implied by submission of the request, so no additional input from the first user may be needed. The second user may correspond to someone listed as having permission to authorize the command (e.g., the supervisor of user 104). Therefore, an action 412 may produce a message asking the second user to confirm that the command should be executed. As discussed below in connection with FIG. 5, the input from the second user can be provided through a similar user interface as that of the first user, e.g., a separate instance of the portal 132.

In some implementations, policies may be encoded in a human-readable format. For example, a policy definition for the policy 400 in YAML format could be as follows:

type: policy
metadata:
name: policy1
rules:
# rule 1
- match:
- “bkshell bookieinfo”
container: bookie
# rule 2
- match:
- “bkshell decommissionbookie”
actions:
- GET https://foo/hook1 (https://foo/hook1)
prompt: true
container: bookie
# rule 3
- match:
- “*”
reject: true

In the example policy definition above, a policy named “policy1” has three rules. The first rule matches against the command “bookieinfo”, which may be a read-only command that returns information about the current state of a machine. The bookieinfo command is described in further detail below, together with additional examples of commands that can be executed in a remote system. The first rule does not include any actions and permits bookieinfo to be executed in a container named “bookie,” which may correspond to a particular machine. For example, bookie could be a Kubernetes pod with one or more applications/services running therein. A Kubernetes container is similar to a virtual machine in that each container may be assigned its own processing, filesystem, memory, and/or other resources. The machine corresponding to bookie can be identified through setting the context, e.g., by selecting one of the options 218 in FIG. 2.

The second rule matches against the command “decommissionbookie”, which may be executed to deactivate a machine. Further, the second rule includes a web hook, “GET https://foo/hook1 (https://foo/hook1)”, which is invoked upon matching the command decommissionbookie. If the web hook executes successfully, decommissionbookie is permitted to execute in the container bookie. The second rule further includes a boolean variable “prompt” that has been set to “true” to indicate that the user will be prompted for additional input (e.g., a yes/no question). The prompt can serve as a request for confirmation that the user wants to execute the command. For example, if the user enters “no”, then the command may be rejected.

The third rule is a catch-all rule for when none of the preceding rules is a match for the command. The third rule matches against the wildcard term “*” and causes the command to be rejected when the command is not covered by the other rules, i.e., when the command is neither bookieinfo nor decommissionbookie.

FIG. 5 shows an example of a web portal 500 for providing input regarding a command from another user, according to some implementations. The web portal 500 may correspond to an instance of the portal 132 in FIG. 1 and includes similar elements as the web portal 200 in FIG. 2. For example, the web portal 500 may include a web page 504 accessible by inputting a URL 510 into an address bar 512 of a web browser. The web portal 500 may be presented to a second user whose approval is needed in order to permit a command to be executed on behalf of a first user. For example, the first user could be a user of the web portal 200, and the second user could be the first user's supervisor. When the command is received at the web portal 200, the web portal 500 may already be running in the second user's web browser. For example, the second user could have entered the URL 510 into the address bar 512 prior to input of the command into the CLI 230 of the web portal 200. However, in some implementations, the web portal 500 may be automatically invoked based on triggering an action in a rule. Therefore, the second user does not necessarily have to be interacting with the web portal 500 prior to the time of the first user's command.

Web portal 500 further includes a prompt 514 for requesting input on whether the second user approves the command. The prompt 514 may include a message indicating who requested the command and the command itself. In this example, the first user (User A) has requested to execute the command “deleteledger” to delete a database named “Ledger123” located in the pod Bookie-0 of cluster Sdb-prod-1. The prompt 514 may request the second user to select one of two options to indicate the second user's approval or disapproval. Additionally or alternatively, the prompt 514 may specify some other type of action the second user can perform to indicate their approval/disapproval. For example, the second user may be required to re-enter the command as confirmation of their approval. Thus, the second user may type the same command into a CLI 530 if the second user wants the command to be executed. If the second user does not want the command to be executed, the second user may expressly indicate their disapproval (e.g., by selecting a “Reject” option) or take no action. In the latter scenario, the command request may timeout or expire due to lack of response from the second user.

The web portal 500 may communicate the second user's input to the computer system 110 through a web socket 540. The web socket 540 may be a connection to a terminal session established by the server 130. The terminal session for the second user is separate from the terminal session for the first user and may be a one-time session created for a specific command request. Alternatively, the terminal session for the second user may be reused for communicating input from the second user in connection with further requests (e.g., another command from User A or a command from a third user).

FIG. 6 shows an example implementation of the activity log 170 in FIG. 1. The activity log 170 can be arranged as a table containing entries 602 that describe command-related activity. In FIG. 6, each row of the table corresponds to a separate entry 602 (e.g., a first entry 602-A, a second entry 602-B, and a third entry 602-C) relating to a command received (e.g., through the portal 132) by the computer system 110. However, the activity log 170 is not necessarily limited to recording command history. In some implementations, the activity log 170 may be part of a database describing other activities that occur within the remote system 112, such as commands received via direct log-in into the remote system 112, or events occurring independently of any command from a user. The activity log 170 may be accessible to an administrator of the remote system 112 (e.g., a system administrator or a member of a security team).

An entry 602 in the activity log 170 may include one or more data fields. Each data field may correspond to a separate column of the table. For example, an entry 602 may include a field 610 containing a timestamp (e.g., a date and time a command was received at the portal 132 and/or a date and time the command was executed after being allowed). An entry 602 may further include a field 620 indicating the user ID of a user who provided the command, a field 630 describing the command (e.g., command name and/or command parameters), a field 640 indicating which machine components the command targeted, and a field 650 indicating the decision whether to allow or reject the command.

As discussed above, the activity log 170 may act as a trusted source of historical information usable for auditing and other purposes. The information in the activity log 170 can be used to correlate commands with events occurring in the remote system 112. For example, configuration changes or changes in the operational states of pods may be recorded in a separate log with timestamps. The computer system 110 can search the activity log 170 for an entry 602 having a timestamp matching (e.g., close or identical to) the timestamp of an event identified by an administrator. The computer system 110 may then present a list of matching entries to the administrator for further investigation.

The activity log 170 can be arranged in chronological order, e.g., with the first row corresponding to the most recent entry. However, the order in which the entries are presented can vary. Further, the activity log 170 may be configurable so that more or fewer items of information are displayed than what is shown in FIG. 6. For instance, the computer system 110 may provide a user interface for viewing the activity log 170, where the user interface enables a user to apply custom-defined filters (e.g., a specific date range, a specific user ID, a specific cluster, etc.), enter search terms (e.g., a specific command string), or rearrange data fields (e.g., switching columns).

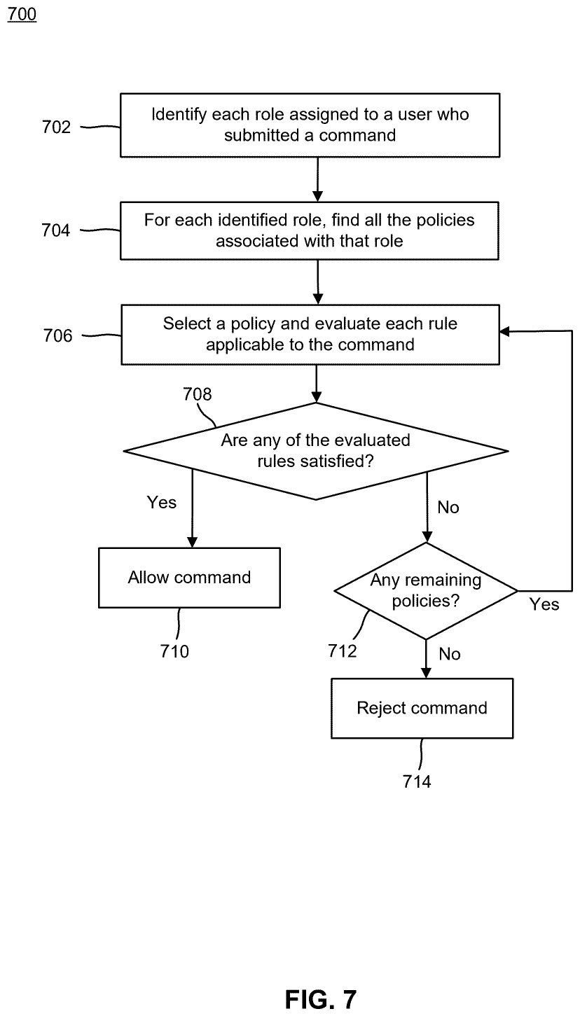

FIG. 7 is a flow diagram of a process 700 for determining whether to allow a command to be executed on a remote system, according to some implementations. The process 700 can be performed using a computer system configured to apply role-based access control, using stored mappings between roles and policies. For example, the functionality depicted in FIG. 7 may involve steps performed by the access control system 120 of the computer system 110. The process 700 may be performed in response to receiving a command request through a portal provided by the computer system (e.g., the portal 132).

The process 700 may begin at block 702, which includes identifying each role assigned to a user who initiated the command request. For example, the access control system 120 may look up a user ID of the user to determine that one or more of the roles 122 are associated with the user ID. If no roles have been assigned to the user, the process 700 may terminate by outputting a decision rejecting the command. Assuming at least one role has been assigned, the process 700 proceeds to block 704.

At block 704, for each role identified in block 702, all the policies associated with that role are found. Referring to FIGS. 3 and 4, each role may be mapped to at least one policy, and each policy may include at least one rule 402 to be evaluated for making an access determination.

At block 706, one of the policies found in block 704 is selected for processing. In situations where multiple policies are found, the policies can be selected one at a time. For instance, every policy of a first role may be individually processed in a random or predetermined order before proceeding to the policies of a second role in like manner. If the selected policy includes one or rules that apply to the command from the user, each applicable rule is evaluated to determine whether the rule is satisfied. Like policies, rules can be evaluated one at a time. If the selected policy includes multiple applicable rules, such rules can be evaluated in a random or predetermined order until one of the rules is satisfied or all rules have been evaluated, whichever occurs first.

At block 708, a determination is made whether any of the rules evaluated for the selected policy are satisfied. As discussed above in reference to FIG. 4, a rule can include one or more conditions 410 and, optionally, one or more actions 412 that operate as additional conditions. Accordingly, evaluation of a rule may involve matching one or more attributes of the command request (e.g., command name, target, and/or timing) against the conditions 410. Further, in some instances, evaluation of a rule may involve triggering an action 412 (e.g., via web hook) and determining whether the action was successfully completed. If at least one of the rules evaluated for the selected policy is satisfied, the process 700 proceeds to block 710. Otherwise, the process 700 proceeds to block 712.

At block 710, a decision to allow the command is output based on determining that a rule is satisfied.

At block 712, a determination is made whether there are any remaining policies to be processed. If so, then the process 700 returns to block 706, where another policy is selected. Otherwise, the process 700 proceeds to block 714.

At block 714, a decision to reject the command is output based on determining that none of the rules which apply to the command is satisfied.

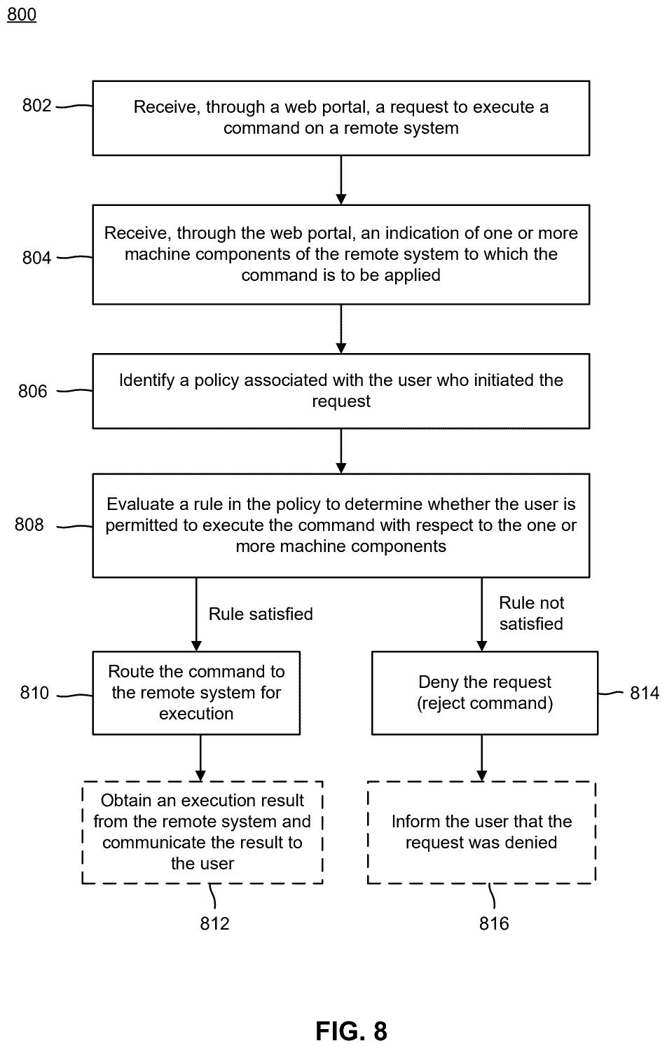

FIG. 8 is a flow diagram of a process 800 for responding to a command request initiated through a web portal, according to some implementations. The process 800 includes functionality discussed above in connection with the process 700 of FIG. 7. Additionally, the process 800 covers interactions between the computer system responding to the command request, the user initiating the command request, and the remote system that is the subject of the command request. The process 800 can be performed by the same computer system performing the process 700.

At block 802, the computer system receives the command request through the web portal. The command request includes a command to be executed on the remote system and is initiated by the user using the web portal. As discussed above, the web portal may provide a command line interface (e.g., CLI 230 in FIG. 2) that accepts commands in the form of text strings. To access the CLI, the user may log into the web portal using their credentials to establish a terminal session as if the user were logging directly into the remote system. Once the user is logged in, the web portal may present the CLI together (e.g., on the same web page) with other user interface elements configured to accept user input. The web portal may issue the command request in response to user input of the command into the CLI. The command request may be received by a server hosting the web portal (e.g., the server 130). Upon receiving the command request, the server may forward the command request to the computer system (e.g., to a separate server hosting the access control system 120) for processing.

At block 804, the computer system receives an indication of one or more machine components of the remote system to which the command is to be applied. The indication is received through the web portal and may be based on user input applied outside of the CLI. For example, in FIG. 2, the user may select a cluster using the dropdown menu 214 and then select one of the pods in the cluster using a corresponding option 218. The indication operates to set the current context for the terminal session. In some implementations, the context is only set once, at the beginning of a terminal session. For example, after the user logs into the web portal, the web portal may prompt the user for context information before displaying the CLI or before allowing the CLI to accept commands. In other implementations, the web portal may permit the user to change the context during the terminal session (e.g., so that a first command is executed on a different machine component than a second command). Once set, the context may remain in effect for all subsequent commands until modified.

In some implementations, the user input specifying the one or more machine components may include input to the CLI. For instance, the CLI may permit the user to navigate a hierarchical directory of machine components. Using FIG. 2 as an example, the user may set the context using the CLI 230 by typing the name of a cluster (e.g., “Sdb-prod-1”), entering a directory command (e.g., “Dir”) to display a list of pods in the cluster, and then typing the name of a listed pod (e.g., “Bookie-0”). Thus, the web portal may provide the user with the ability to set the context in different ways, using the CLI and graphical control elements in the user interface of the web portal.

The indication of one or more machine components may be received as part of the command request in block 802. For example, the command request may include a field identifying the one or more machine components, and the web portal may be configured to form the command request by appending the field to a command string provided by the user. Alternatively, the web portal may be configured to send the indication separately from the command request. For instance, the web portal may communicate context information to the computer system whenever the user modifies the context. In implementations where the indication is sent separately, the web portal may simply forward each command string received at the CLI as a standalone command request (e.g., whenever the user types in a command string followed by the “Enter” key).

At block 806, the computer system identifies a policy associated with the user, i.e., the person who initiated the command request received in block 802. If the user is logged into the web portal, the computer system may already be aware of the identity of the user (e.g., a user ID) prior to receiving the command request. The computer system can identify the policy according to the functionality in blocks 702, 704, and 706 of FIG. 7. Specifically, block 806 may include obtaining a stored mapping between roles and policies, and selecting a policy to which a role assigned to the user is mapped.

At block 808, the computer system evaluates a rule in the identified policy to determine whether the user is permitted to execute the command with respect to the one or more machine components. The rule in block 808 can be any rule governing usage of the command. In some implementations, each individual rule in a policy applies to a different command. Thus, the identified policy may only include one rule applicable to the command being requested. However, it is possible that the identified policy includes two or more rules that apply to the same command, in which case multiple rules may be evaluated. The result of the evaluation in block 808 may correspond to either of the decisions leading to blocks 710 and 714 of FIG. 7. If the rule is satisfied, the process 800 proceeds to block 810.

At block 810, the computer system grants the command request (i.e., allows the command) by routing the command to the remote system for execution. The functionality in block 810 may be performed in response to determining (in block 808) that the command request meets every condition specified in the rule of the identified policy.

After routing the command to the remote system, the computer system may optionally obtain (at block 812) an execution result from the remote system. The remote system may automatically return the execution result after applying the command to the indicated machine component(s). Alternatively, the computer system may request the execution results after a certain amount of time has elapsed from when the command was routed. The computer system may communicate the execution result to the user through the web portal. For instance, the computer system may instruct the web portal to display the execution result in the CLI.

If the rule of the identified policy is not satisfied (and assuming there are no other policies or rules to evaluate), the process 800 proceeds to block 814 instead of block 810. At block 814, the computer system denies the command request, so the command is not routed for execution. The functionality in block 814 may be performed in response to determining (in block 808) that the command request fails to meet at least one of the conditions specified in the rule of the identified policy.

The command request can be denied without providing any feedback to the user. Alternatively, at block 816, the computer system may optionally inform the user that the command request was denied. For example, the computer system may instruct the web portal to display an error message in the CLI or in another part of the web portal. The error message may include an explanation of why the command request was denied. For instance, the error message can describe each condition that failed to be met.

The following is a list of example commands that could potentially be executed on a remote system. These commands can be applied to servers (e.g., individual pods) that have been configured to provide a database service. In some application platforms, such servers are referred to as “bookies”. Each bookie can maintain a ledger directory, a journal directory, and an index directory. The ledger directory contains one or more log-streamed datastores (ledgers). Data entries from different ledgers can be aggregated and sequentially written into an entry log file in the ledger directory. The journal directory contains one or more journal files, which store transaction logs describing updates to ledgers. The index directory contains one or more index files. Each index file is created for a corresponding ledger and contains index values (e.g., positional offsets) that can be used to look up entries in the entry log file.

Depending on the configuration of the remote system, there can be any number of commands that the remote system is capable of executing. Not all configurations of a remote system involve a database service. Further, a remote system providing a database service may be configured based on an instruction set with commands different from those listed below. Accordingly, this list is an illustrative, non-exhaustive, and non-limiting example.

### Examples of Safe Commands (e.g., Read-only)

### Bookieinfo

Returns disk space utilization information for an individual bookie and the cluster containing the bookie. Specifically, it returns the total and free (unused) disk capacity of the ledger directory maintained by the bookie. The bookieinfo command also returns the total disk capacity of the cluster. This command can be used to troubleshoot network connectivity issues, since it uses a separate client connection to communicate with each bookie.
   Bookiesanity [-entries <n>] [-timeout <m>]
Performs a sanity check on the bookies in a cluster by making sure it can connect to them. Can optionally specify n number of entries to return and a timeout of m seconds to wait for a response.

### Lastmark

The last mark is a checkpoint in a log stream and indicates which data entries have been persisted to the entry log in the ledger directory. All transactions added before the last mark are persisted. This command prints the journal ID, the name of the journal file on disk, and the last mark position in the journal file.
   Ledger <ledger_id>
Prints the contents of the index file for the given ledger.
   Listbookies [-readwrite |-readonly]
Lists all bookies in the cluster that have been registered. Can list bookies which are running in either read-write mode or read-only mode. Bookies that are offline (not in service) will not show on the list.

### Examples of Destructive Commands (e.g., Read-Write)

Autorecovery [-enable] [-disable]
Turns on/off an auto-recovery feature for a cluster. When auto-recovery is enabled, ledger replication tasks will run, and an auditor process ensures that ledger entries are replicated to enough bookies to have a quorum. When disabled, replication tasks are blocked. Auto-recovery may be disabled in connection with performing maintenance on a cluster that requires taking bookies out of service temporarily.

### Bookieformat

Formats the contents of a bookie. This command deletes the existing journal, index, and ledger directories on the bookie.
   Deleteledger-ledgerid <ledger_id>
Deletes the given ledger.

The above-listed instructions are divided into two categories: safe commands and destructive commands. Safe commands include commands that don't produce configuration changes in the remote system. A read-only command is a prototypical example of a safe command. Destructive commands include commands that make configuration changes or otherwise modify the state of a component in the remote system. Write or read-write commands are considered destructive.

Limiting the availability of destructive commands can help reduce the likelihood of a remote system becoming compromised, whether due to user error or the actions of a malicious user. One way to limit availability of destructive commands is to expressly specify which commands a particular user should have access to. Accordingly, the policies described herein may tend to include fewer and/or more restrictive rules governing usage of destructive commands compared to rules governing usage of safe commands. For example, among all the users who can access a remote system via web portal, only a small subset of such users may be associated with a policy relating to a destructive command. This subset of users is ordinarily composed of highly privileged individuals who are not representative of typical users of the remote system. It can generally be expected that the policies associated with this subset of users are more comprehensive (e.g., covering a greater number or variety of commands) than the policies of typical users. Further, a policy associated with a higher-privileged user may impose fewer conditions on the execution of a destructive command compared to a policy enabling a lesser-privileged user to execute the same destructive command. Thus, the ease with which destructive commands can be executed may be commensurate with a user's permission level. In comparison, there may be less disparity between users as to the availability of safe commands.

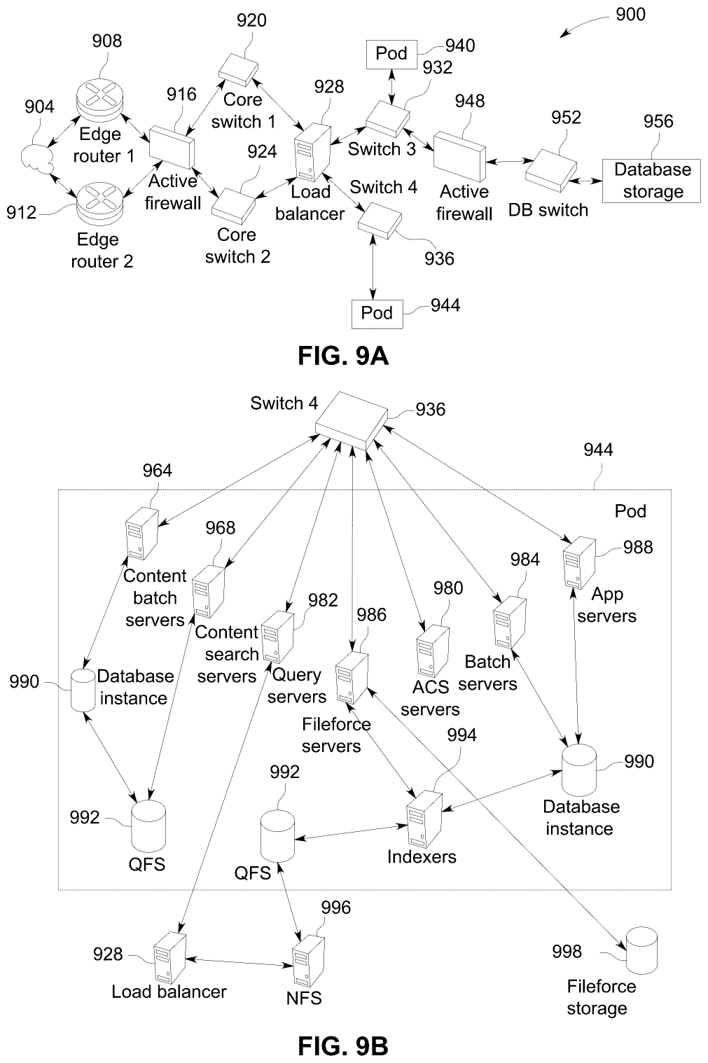

FIG. 9A shows a system diagram illustrating architectural components of an on-demand service environment 900, in accordance with some implementations. For instance, the on-demand service environment 900 may correspond to an implementation of computing environment 100 in FIG. 1. A client machine located in the cloud 904 (or Internet) may communicate with the on-demand service environment via one or more edge routers 908 and 912. The edge routers may communicate with one or more core switches 920 and 924 via firewall 916. The core switches may communicate with a load balancer 928, which may distribute server load over different pods, such as pods 940 and 944. The pods 940 and 944, which may each include one or more servers and/or other computing resources, may perform data processing and other operations used to provide on-demand services. Communication with the pods may be conducted via pod switches 932 and 936. Components of the on-demand service environment may communicate with a database storage system 956 via a database firewall 948 and a database switch 952.

As shown in FIGS. 9A and 9B, accessing an on-demand service environment may involve communications transmitted among a variety of different hardware and/or software components. Further, the on-demand service environment 900 is a simplified representation of an actual on-demand service environment. For example, while only one or two devices of each type are shown in FIGS. 9A and 9B, some implementations of an on-demand service environment may include anywhere from one to many devices of each type. Also, the on-demand service environment need not include each device shown in FIGS. 9A and 9B or may include additional devices not shown in FIGS. 9A and 9B.

Moreover, one or more of the devices in the on-demand service environment 900 may be implemented on the same physical device or on different hardware. Some devices may be implemented using hardware or a combination of hardware and software. Thus, terms such as “data processing apparatus,” “machine,” “server” and “device” as used herein are not limited to a single hardware device, but rather include any hardware and software configured to provide the described functionality.

The cloud 904 is intended to refer to a data network or plurality of data networks, often including the Internet. Client machines located in the cloud 904 may communicate with the on-demand service environment to access services provided by the on-demand service environment. For example, client machines may access the on-demand service environment to retrieve, store, edit, and/or process information.

In some implementations, the edge routers 908 and 912 route packets between the cloud 904 and other components of the on-demand service environment 900. The edge routers 908 and 912 may employ the Border Gateway Protocol (BGP). The BGP is the core routing protocol of the Internet. The edge routers 908 and 912 may maintain a table of IP networks or ‘prefixes’ which designate network reachability among autonomous systems on the Internet.

In one or more implementations, the firewall 916 may protect the inner components of the on-demand service environment 900 from Internet traffic. The firewall 916 may block, permit, or deny access to the inner components of the on-demand service environment 900 based upon a set of rules and other criteria. The firewall 916 may act as one or more of a packet filter, an application gateway, a stateful filter, a proxy server, or any other type of firewall.

In some implementations, the core switches 920 and 924 are high-capacity switches that transfer packets within the on-demand service environment 900. The core switches 920 and 924 may be configured as network bridges that quickly route data between different components within the on-demand service environment. In some implementations, the use of two or more core switches 920 and 924 may provide redundancy and/or reduced latency.

In some implementations, the pods 940 and 944 may perform the core data processing and service functions provided by the on-demand service environment. Each pod may include various types of hardware and/or software computing resources. An example of the pod architecture is discussed in greater detail with reference to FIG. 9B.

In some implementations, communication between the pods 940 and 944 may be conducted via the pod switches 932 and 936. The pod switches 932 and 936 may facilitate communication between the pods 940 and 944 and client machines located in the cloud 904, for example via core switches 920 and 924. Also, the pod switches 932 and 936 may facilitate communication between the pods 940 and 944 and the database storage 956.

In some implementations, the load balancer 928 may distribute workload between the pods 940 and 944. Balancing the on-demand service requests between the pods may assist in improving the use of resources, increasing throughput, reducing response times, and/or reducing overhead. The load balancer 928 may include multilayer switches to analyze and forward traffic.

In some implementations, access to the database storage 956 may be guarded by a database firewall 948. The database firewall 948 may act as a computer application firewall operating at the database application layer of a protocol stack. The database firewall 948 may protect the database storage 956 from application attacks such as structure query language (SQL) injection, database rootkits, and unauthorized information disclosure.

In some implementations, the database firewall 948 may include a host using one or more forms of reverse proxy services to proxy traffic before passing it to a gateway router. The database firewall 948 may inspect the contents of database traffic and block certain content or database requests. The database firewall 948 may work on the SQL application level atop the TCP/IP stack, managing applications' connection to the database or SQL management interfaces as well as intercepting and enforcing packets traveling to or from a database network or application interface.

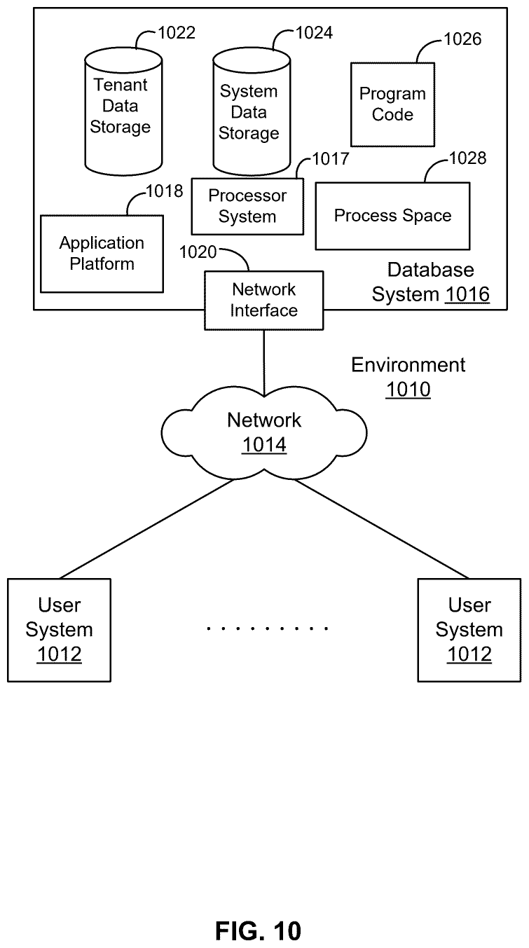

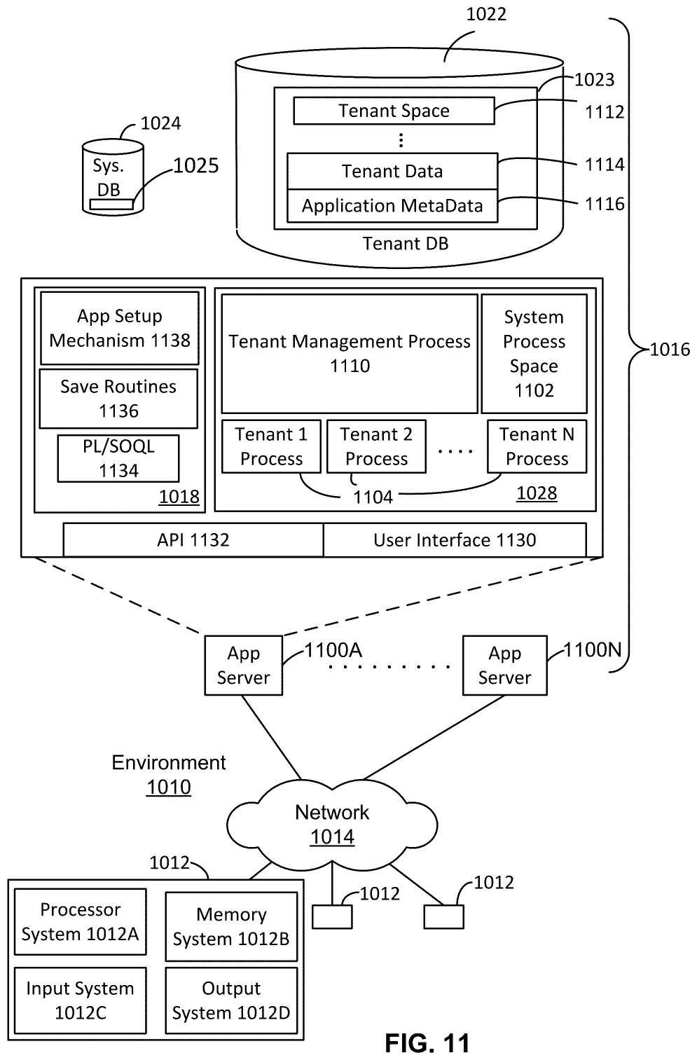

In some implementations, communication with the database storage system 956 may be conducted via the database switch 952. The multi-tenant database system 956 may include more than one hardware and/or software components for handling database queries. Accordingly, the database switch 952 may direct database queries transmitted by other components of the on-demand service environment (e.g., the pods 940 and 944) to the correct components within the database storage system 956. In some implementations, the database storage system 956 is an on-demand database system shared by many different organizations. The on-demand database system may employ a multi-tenant approach, a virtualized approach, or any other type of database approach. An on-demand database system is discussed in greater detail with reference to FIGS. 10 and 11.

FIG. 9B shows a system diagram illustrating the architecture of the pod 944, in accordance with one implementation. The pod 944 may be used to render services to a user of the on-demand service environment 900. In some implementations, each pod may include a variety of servers and/or other systems. The pod 944 includes one or more content batch servers 964, content search servers 968, query servers 982, Fileforce servers 986, access control system (ACS) servers 980, batch servers 984, and application (app) servers 988. Also, the pod 944 includes database instances 990, quick file systems (QFS) 992, and indexers 994. In one or more implementations, some or all communication between the servers in the pod 944 may be transmitted via the switch 936.

In some implementations, the application servers 988 may include a hardware and/or software framework dedicated to the execution of procedures (e.g., programs, routines, scripts) for supporting the construction of applications provided by the on-demand service environment 900 via the pod 944. Some such procedures may include operations for providing the services described herein. The content batch servers 964 may handle requests internal to the pod. These requests may be long-running and/or not tied to a particular customer. For example, the content batch servers 964 may handle requests related to log mining, cleanup work, and maintenance tasks.

The content search servers 968 may provide query and indexer functions. For example, the functions provided by the content search servers 968 may allow users to search through content stored in the on-demand service environment. The Fileforce servers 986 may manage requests for information stored in the Fileforce storage 998. The Fileforce storage 998 may store information such as documents, images, and basic large objects (BLOBs). By managing requests for information using the Fileforce servers 986, the image footprint on the database may be reduced.

The query servers 982 may be used to retrieve information from one or more file systems. For example, the query servers 982 may receive requests for information from the app servers 988 and then transmit information queries to network file systems (NFS) 996 located outside the pod. The pod 944 may share a database instance 990 configured as a multi-tenant environment in which different organizations share access to the same database. Additionally, services rendered by the pod 944 may require various hardware and/or software resources. In some implementations, the ACS servers 980 may control access to data, hardware resources, or software resources.

In some implementations, the batch servers 984 may process batch jobs, which are used to run tasks at specified times. Thus, the batch servers 984 may transmit instructions to other servers, such as the app servers 988, to trigger the batch jobs. For some implementations, the QFS 992 may be an open source file system. The QFS may serve as a rapid-access file system for storing and accessing information available within the pod 944. The QFS 992 may support some volume management capabilities, allowing many disks to be grouped together into a file system. File system metadata can be kept on a separate set of disks, which may be useful for streaming applications where long disk seeks cannot be tolerated. Thus, the QFS system may communicate with one or more content search servers 968 and/or indexers 994 to identify, retrieve, move, and/or update data stored in the NFS 996 and/or other storage systems.

In some implementations, one or more query servers 982 may communicate with the NFS 996 to retrieve and/or update information stored outside of the pod 944. The NFS 996 may allow servers located in the pod 944 to access information to access files over a network in a manner similar to how local storage is accessed. In some implementations, queries from the query servers 982 may be transmitted to the NFS 996 via the load balancer 928, which may distribute resource requests over various resources available in the on-demand service environment. The NFS 996 may also communicate with the QFS 992 to update the information stored on the NFS 996 and/or to provide information to the QFS 992 for use by servers located within the pod 944.

In some implementations, the pod may include one or more database instances 990. The database instance 990 may transmit information to the QFS 992. When information is transmitted to the QFS, it may be available for use by servers within the pod 944 without requiring an additional database call. In some implementations, database information may be transmitted to the indexer 994. Indexer 994 may provide an index of information available in the database 990 and/or QFS 992. The index information may be provided to Fileforce servers 986 and/or the QFS 992.

FIG. 10 shows a block diagram of an environment 1010 wherein an on-demand database service might be used, in accordance with some implementations. Environment 1010 includes an on-demand database service 1016. User system 1012 may be any machine or system that is used by a user to access a database system. For example, any of user systems 1012 can be a handheld computing system, a mobile phone, a laptop computer, a workstation, and/or a network of computing systems. As illustrated in FIGS. 10 and 11, user systems 1012 might interact via a network 1014 with the on-demand database service 1016.

An on-demand database service, such as system 1016, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 1016” and “system 1016” will be used interchangeably herein. A database image may include one or more database objects. A relational database management system (RDBMS) or the equivalent may execute storage and retrieval of information against the database object(s). Application platform 1018 may be a framework that allows the applications of system 1016 to run, such as the hardware and/or software, e.g., the operating system. In an implementation, on-demand database service 1016 may include an application platform 1018 that enables creation, managing and executing one or more applications developed by the provider of the on-demand database service, users accessing the on-demand database service via user systems 1012, or third party application developers accessing the on-demand database service via user systems 1012.

One arrangement for elements of system 1016 is shown in FIG. 10, including a network interface 1020, application platform 1018, tenant data storage 1022 for tenant data (e.g., tenant data 1023 in FIG. 11), system data storage 1024 for system data 1025 accessible to system 1016 and possibly multiple tenants, program code 1026 for implementing various functions of system 1016, and a process space 1028 for executing MTS system processes and tenant-specific processes, such as running applications as part of an application hosting service. Additional processes that may execute on system 1016 include database indexing processes.

The users of user systems 1012 may differ in their respective capacities, and the capacity of a particular user system 1012 might be entirely determined by permissions (permission levels) for the current user. For example, where a call center agent is using a particular user system 1012 to interact with system 1016, the user system 1012 has the capacities allotted to that call center agent. However, while an administrator is using that user system to interact with system 1016, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users may have different capabilities with regard to accessing and modifying application and database information, depending on a user's security or permission level.

Network 1014 is any network or combination of networks of devices that communicate with one another. For example, network 1014 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network (e.g., the Internet), that network will be used in many of the examples herein. However, it should be understood that the networks used in some implementations are not so limited, although TCP/IP is a frequently implemented protocol.

User systems 1012 might communicate with system 1016 using TCP/IP and, at a higher network level, use other common Internet protocols to communicate, such as HTTP, FTP, AFS, WAP, etc. In an example where HTTP is used, user system 1012 might include an HTTP client commonly referred to as a “browser” for sending and receiving HTTP messages to and from an HTTP server at system 1016. Such an HTTP server might be implemented as the sole network interface between system 1016 and network 1014, but other techniques might be used as well or instead. In some implementations, the interface between system 1016 and network 1014 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In some implementations, system 1016, shown in FIG. 10, implements a web-based customer relationship management (CRM) system. For example, in some implementations, system 1016 includes application servers configured to implement and execute CRM software applications as well as provide related data, code, forms, webpages and other information to and from user systems 1012 and to store to, and retrieve from, a database system related data, objects, and webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain implementations, system 1016 implements applications other than, or in addition to, a CRM application. For example, system 1016 may provide tenant access to multiple hosted (standard and custom) applications. User (or third party developer) applications, which may or may not include CRM, may be supported by the application platform 1018, which manages creation, storage of the applications into one or more database objects and executing of the applications in a virtual machine in the process space of the system 1016.

Each user system 1012 could include a desktop personal computer, workstation, laptop, PDA, cell phone, or any wireless access protocol (WAP) enabled device or any other computing system capable of interfacing directly or indirectly to the Internet or other network connection. User system 1012 typically runs an HTTP client, e.g., a browsing program, such as Microsoft's Internet Explorer® browser, Mozilla's Firefox® browser, Opera's browser, or a WAP-enabled browser in the case of a cell phone, PDA or other wireless device, or the like, allowing a user (e.g., subscriber of the multi-tenant database system) of user system 1012 to access, process and view information, pages and applications available to it from system 1016 over network 1014.

Each user system 1012 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 1016 or other systems or servers. For example, the user interface device can be used to access data and applications hosted by system 1016, and to perform searches on stored data, and otherwise allow a user to interact with various GUI pages that may be presented to a user. As discussed above, implementations are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to some implementations, each user system 1012 and all of its components are operator configurable using applications, such as a browser, including computer code run using a central processing unit such as an Intel Pentium® processor or the like. Similarly, system 1016 (and additional instances of an MTS, where more than one is present) and all of their components might be operator configurable using application(s) including computer code to run using a central processing unit such as processor system 1017, which may include an Intel Pentium® processor or the like, and/or multiple processor units.

A computer program product implementation includes a machine-readable storage medium (media) having instructions stored thereon/in which can be used to program a computer to perform any of the processes of the implementations described herein. Computer code for operating and configuring system 1016 to intercommunicate and to process webpages, applications and other data and media content as described herein are preferably downloaded and stored on a hard disk, but the entire program code, or portions thereof, may also be stored in any other volatile or non-volatile memory medium or device, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, or transmitted over any other conventional network connection (e.g., extranet, VPN, LAN, etc.) using any communication medium and protocols (e.g., TCP/IP, HTTP, HTTPS, Ethernet, etc.). It will also be appreciated that computer code for carrying out disclosed operations can be implemented in any programming language that can be executed on a client system and/or server or server system such as, for example, C, C++, HTML, any other markup language, Java®, JavaScript®, ActiveX®, any other scripting language, such as VBScript, and many other programming languages as are well known may be used. (Java®, JavaScript®, and Oracle® are registered trademarks of Oracle Corp. and/or its affiliates).

According to some implementations, each system 1016 is configured to provide webpages, forms, applications, data and media content to user (client) systems 1012 to support the access by user systems 1012 as tenants of system 1016. As such, system 1016 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include logically and/or physically connected servers distributed locally or across one or more geographic locations. Additionally, the term “server” is meant to include a computing system, including processing hardware and process space(s), and an associated storage system and database application (e.g., OODBMS or RDBMS) as is well known in the art.

It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 11 also shows a block diagram of environment 1010 further illustrating system 1016 and various interconnections, in accordance with some implementations. FIG. 11 shows that user system 1012 may include processor system 1012A, memory system 1012B, input system 1012C, and output system 1012D. FIG. 10 shows network 1014 and system 1016. FIG. 11 also shows that system 1016 may include tenant data storage 1022, tenant data 1023, system data storage 1024, system data 1025, User Interface (UI) 1130, Application Program Interface (API) 1132, PL/SOQL 1134, save routines 1136, application setup mechanism 1138, applications servers 1100A-1100N, system process space 1102, tenant process spaces 1104, tenant management process space 1110, tenant storage area 1112, user storage 1114, and application metadata 1116. In other implementations, environment 1010 may not have the same elements as those listed above and/or may have other elements instead of, or in addition to, those listed above.

User system 1012, network 1014, system 1016, tenant data storage 1022, and system data storage 1024 were discussed above in FIG. 10. Regarding user system 1012, processor system 1012A may be any combination of processors. Memory system 1012B may be any combination of one or more memory devices, short term, and/or long term memory. Input system 1012C may be any combination of input devices, such as keyboards, mice, trackballs, scanners, cameras, and/or interfaces to networks. Output system 1012D may be any combination of output devices, such as monitors, printers, and/or interfaces to networks. As shown by FIG. 11, system 1016 may include a network interface 1020 (of FIG. 10) implemented as a set of HTTP application servers 1100, an application platform 1018, tenant data storage 1022, and system data storage 1024. Also shown is system process space 1102, including individual tenant process spaces 1104 and a tenant management process space 1110. Each application server 1100 may be configured to tenant data storage 1022 and the tenant data 1023 therein, and system data storage 1024 and the system data 1025 therein to serve requests of user systems 1012. The tenant data 1023 might be divided into individual tenant storage areas 1112, which can be either a physical arrangement and/or a logical arrangement of data. Within each tenant storage area 1112, user storage 1114 and application metadata 1116 might be similarly allocated for each user. For example, a copy of a user's most recently used (MRU) items might be stored to user storage 1114. Similarly, a copy of MRU items for an entire organization that is a tenant might be stored to tenant storage area 1112. A UI 1130 provides a user interface and an API 1132 provides an application programmer interface to system 1016 resident processes to users and/or developers at user systems 1012. The tenant data and the system data may be stored in various databases, such as Oracle® databases.

Application platform 1018 includes an application setup mechanism 1138 that supports application developers' creation and management of applications, which may be saved as metadata into tenant data storage 1022 by save routines 1136 for execution by subscribers as tenant process spaces 1104 managed by tenant management process 1110 for example. Invocations to such applications may be coded using PL/SOQL 1134 that provides a programming language style interface extension to API 1132. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, filed Sep. 21, 2007, which is hereby incorporated by reference in its entirety and for all purposes. Invocations to applications may be detected by system processes, which manage retrieving application metadata 1116 for the subscriber making the invocation and executing the metadata as an application in a virtual machine.

Each application server 1100 may be communicably coupled to database systems, e.g., having access to system data 1025 and tenant data 1023, via a different network connection. For example, one application server 1100 might be coupled via the network 1014 (e.g., the Internet), another application server 1100 might be coupled via a direct network link, and another application server 1100 might be coupled by yet a different network connection. Transfer Control Protocol and Internet Protocol (TCP/IP) are typical protocols for communicating between application servers 1100 and the database system. However, other transport protocols may be used to optimize the system depending on the network interconnect used.

In certain implementations, each application server 1100 is configured to handle requests for any user associated with any organization that is a tenant. Because it is desirable to be able to add and remove application servers from the server pool at any time for any reason, there is preferably no server affinity for a user and/or organization to a specific application server 1100. In some implementations, therefore, an interface system implementing a load balancing function (e.g., an F5 Big-IP load balancer) is communicably coupled between the application servers 1100 and the user systems 1012 to distribute requests to the application servers 1100. In some implementations, the load balancer uses a least connections algorithm to route user requests to the application servers 1100. Other examples of load balancing algorithms, such as round robin and observed response time, also can be used. For example, in certain implementations, three consecutive requests from the same user could hit three different application servers 1100, and three requests from different users could hit the same application server 1100. In this manner, system 1016 is multi-tenant, wherein system 1016 handles storage of, and access to, different objects, data and applications across disparate users and organizations.

As an example of storage, one tenant might be a company that employs a sales force where each call center agent uses system 1016 to manage their sales process. Thus, a user might maintain contact data, leads data, customer follow-up data, performance data, goals and progress data, etc., all applicable to that user's personal sales process (e.g., in tenant data storage 1022). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a call center agent is visiting a customer and the customer has Internet access in their lobby, the call center agent can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 1016 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 1016 might also maintain system level data usable by multiple tenants or other data. Such system level data might include industry reports, news, postings, and the like that are sharable among tenants.

In certain implementations, user systems 1012 (which may be client machines/systems) communicate with application servers 1100 to request and update system-level and tenant-level data from system 1016 that may require sending one or more queries to tenant data storage 1022 and/or system data storage 1024. System 1016 (e.g., an application server 1100 in system 1016) automatically generates one or more SQL statements (e.g., SQL queries) that are designed to access the desired information. System data storage 1024 may generate query plans to access the requested data from the database.

Each database can generally be viewed as a collection of objects, such as a set of logical tables, containing data fitted into predefined categories. A “table” is one representation of a data object and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for account, contact, lead, and opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. Pat. No. 7,779,039, titled CUSTOM ENTITIES AND FIELDS IN A MULTI-TENANT DATABASE SYSTEM, by Weissman, et al., and which is hereby incorporated by reference in its entirety and for all purposes, teaches systems and methods for creating custom objects as well as customizing standard objects in a multi-tenant database system. In some implementations, for example, all custom entity data rows are stored in a single multi-tenant physical table, which may contain multiple logical tables per organization. In some implementations, multiple “tables” for a single customer may actually be stored in one large table and/or in the same table as the data of other customers.

These and other aspects of the disclosure may be implemented by various types of hardware, software, firmware, etc. For example, some features of the disclosure may be implemented, at least in part, by machine-program product that include program instructions, state information, etc., for performing various operations described herein. Examples of program instructions include both machine code, such as produced by a compiler, and files containing higher-level code that may be executed by the computer using an interpreter. Examples of machine-program product include, but are not limited to, magnetic media such as hard disks, floppy disks, and magnetic tape; optical media such as CD-ROM disks; magneto-optical media; and hardware devices that are specially configured to store and perform program instructions, such as read-only memory devices (“ROM”) and random access memory (“RAM”).

While one or more implementations and techniques are described with reference to an implementation in which a service cloud console is implemented in a system having an application server providing a front end for an on-demand database service capable of supporting multiple tenants, the one or more implementations and techniques are not limited to multi-tenant databases nor deployment on application servers. Implementations may be practiced using other database architectures, e.g., Oracle®, Db2® by IBM and the like without departing from the scope of the implementations claimed.

Any of the above implementations may be used alone or together with one another in any combination. Although various implementations may have been motivated by various deficiencies with the prior art, which may be discussed or alluded to in one or more places in the specification, the implementations do not necessarily address any of these deficiencies. In other words, different implementations may address different deficiencies that may be discussed in the specification. Some implementations may only partially address some deficiencies or just one deficiency that may be discussed in the specification, and some implementations may not address any of these deficiencies.

While various implementations have been described herein, it should be understood that they have been presented by way of example only, and not limitation. Thus, the breadth and scope of the present application should not be limited by any of the implementations described herein but should be defined only in accordance with the following and later-submitted claims and their equivalents.

What is claimed is:

1. A computer-implemented method comprising:
receiving, by a computer system through a web portal, a request to execute a command on a remote system, wherein the request is generated in response to a user inputting the command at the web portal;
receiving, by the computer system through the web portal, an indication of one or more machine components of the remote system to which the command is to be applied;
identifying, by the computer system, a policy associated with the user, wherein the policy includes a rule governing usage of the command;
evaluating, by the computer system, the rule to determine whether the user is permitted to execute the command with respect to the one or more machine components; and
routing, by the computer system, the command to the remote system for execution based on determining that the rule is satisfied.

2. The computer-implemented method of claim 1, wherein the remote system has a pod architecture comprising a plurality of pods grouped into two or more clusters, and wherein the indication of one or more machine components of the remote system to which the command is to be applied comprises information identifying:
a single pod among the plurality of pods,
a single cluster among the two or more clusters, or
a subset of pods within the same cluster.

3. The computer-implemented method of claim 1, further comprising:
returning a result of executing the command to a computing device of the user through the web portal;
wherein the remote system is a software deployment system running a software application using the one or more machine components; and
wherein the command captures information about a runtime state of the one or more machine components.

4. The computer-implemented method of claim 1, wherein the command is typed into a command line interface (CLI) provided by the web portal, the CLI being identical or substantially identical in appearance to a CLI available through logging directly into the remote system.

5. The computer-implemented method of claim 1, further comprising:
obtaining a stored mapping between roles and policies, each role being assignable to one or more users and mapped to one or more policies; and
identifying the policy associated with the user as being a policy to which a role assigned to the user is mapped.

6. The computer-implemented method of claim 1, wherein the rule comprises a condition on when the command can be executed, a condition on which machine components the command can be applied to, or both.

7. The computer-implemented method of claim 1, wherein evaluation of the rule causes a message to be communicated to a second user, the message prompting the second user for input on whether the request should be granted.

8. The computer-implemented method of claim 7, wherein the rule requires the second user to input the command through a separate web portal.

9. The computer-implemented method of claim 1, further comprising creating a record of the request in an activity log, the record comprising a result of evaluating the rule and further comprising at least one of:
an identifier of the user;
an identifier of the command;
an identifier of the one or more machine components; or
a timestamp associated with the request.

10. The computer-implemented method of claim 1, wherein the policy associated with the user comprises a set of rules for determining when the user is permitted to execute commands on the remote system, each rule in the set of rules being applicable to a different command.

11. A computer system comprising:
one or more processors; and
memory storing instructions that, when executed by the one or more processors, cause the computer system to:
receive, through a web portal, a request to execute a command on a remote system, wherein the request is generated in response to a user inputting the command at the web portal;
receive, through the web portal, an indication of one or more machine components of the remote system to which the command is to be applied;
identify a policy associated with the user, wherein the policy includes a rule governing usage of the command;
evaluate the rule to determine whether the user is permitted to execute the command with respect to the one or more machine components; and
route the command to the remote system for execution based on determining that the rule is satisfied.

12. The computer system of claim 11, wherein the remote system has a pod architecture comprising a plurality of pods grouped into two or more clusters, and wherein the indication of one or more machine components of the remote system to which the command is to be applied comprises information identifying:
a single pod among the plurality of pods,
a single cluster among the two or more clusters, or
a subset of pods within the same cluster.

13. The computer system of claim 11, wherein:
the instructions further cause the computer system to return a result of executing the command to a computing device of the user through the web portal;
the remote system is a software deployment system running a software application using the one or more machine components; and
the command captures information about a runtime state of the one or more machine components.

14. The computer system of claim 11, wherein the command is typed into a command line interface (CLI) provided by the web portal, the CLI being identical or substantially identical in appearance to a CLI available through logging directly into the remote system.

15. The computer system of claim 11, wherein the instructions further cause the computer system to:
obtain a stored mapping between roles and policies, each role being assignable to one or more users and mapped to one or more policies; and
identify the policy associated with the user as being a policy to which a role assigned to the user is mapped.

16. The computer system of claim 11, wherein the rule comprises a condition on when the command can be executed, a condition on which machine components the command can be applied to, or both.

17. The computer system of claim 11, wherein evaluation of the rule causes a message to be communicated to a second user, the message prompting the second user for input on whether the request should be granted.

18. The computer system of claim 17, wherein the rule requires the second user to input the command through a separate web portal.

19. The computer system of claim 11, wherein the instructions further cause the computer system to create a record of the request in an activity log, the record comprising a result of evaluating the rule and further comprising at least one of:
an identifier of the user;
an identifier of the command;
an identifier of the one or more machine components; or
a timestamp associated with the request.

20. A non-transitory computer-readable medium storing program code, the program code including instructions that are executable by one or more processors of a computer system to configure the computer system to:
receive, through a web portal, a request to execute a command on a remote system, wherein the request is generated in response to a user inputting the command at the web portal;
receive, through the web portal, an indication of one or more machine components of the remote system to which the command is to be applied;
identify a policy associated with the user, wherein the policy includes a rule governing usage of the command;
evaluate the rule to determine whether the user is permitted to execute the command with respect to the one or more machine components; and
route the command to the remote system for execution based on determining that the rule is satisfied.
